(19) United States
(12) Patent Application Publication
(10) Pub. No.: US 2022/0288601 A1
(43) Pub. Date: Sep. 15, 2022

(54) REAL-TIME MONITORING AND ESTIMATION SYSTEM FOR WEAR IN RUBBER LINERS AND LIFTER BARS UTILIZED IN ORE GRINDING MILLS

(71) Applicant: FKK GÜNEY OTO LAST?K TAKOZ SANAY? T?C A.?., Tekkeköy/Samsun (TR)

(72) Inventor: Ahmet Altuncu, Tekkeköy/Samsun (TR)

(73) Assignee: FKK GÜNEY OTO LAST?K TAKOZ SANAY? T?C A.?., Tekkeköy/Samsun (TR)

(21) Appl. No.: 17/632,790

(22) PCT Filed: Sep. 23, 2021
(86) PCT No.: PCT/TR2021/050973

§ 371 Date: Feb. 3, 2022

(30) Foreign Application Priority Data
Dec. 31, 2020 (TR) 2020/22675

(51) Int. Cl. B02C 17/18; B02C 17/22

(52) U.S. Cl. CPC B02C 17/1805; B02C 17/225; B02C 2210/01

(57) ABSTRACT

The invention relates to a system that enables real-time monitoring of wear and tear occurring in rubber liners and lifter bars used in the internal structure of the ore grinding mills employed in the mining sector, in addition to obtaining estimations as to the replacement times of worn parts.

### TECHNICAL FIELD

The invention relates to a system that enables real-time monitoring of wear and tear occurring in rubber liners and lifter bars used in the internal structure of the ore grinding mills employed in the mining sector, in addition to obtaining estimations as to the replacement times of worn parts.

### BACKGROUND ART

Mills are utilized to grind ore in the mining sector. The interior of the mills is generally lined with rubber liners and lifter bars in order to impart the grinding motion and protect the mill body against abrasion. Liners and lifter bars that wear away over time are replaced by new ones; however, replacement time and replacement procedures are determined and implemented based on technical know-how and experience since the current technology does not enable instant (real-time) monitoring of wear. Stoppages due to replacement procedures and the replacement of liners and lifter bars that are not completely worn away lead to loss of time and money.

The equipment with the highest initial investment costs and operating costs in ore processing facilities are ore grinding mills. Moreover, with a 35% share in energy consumption, grinding processes come first in terms of energy consumption in such facilities. Ball mills, rod mills, autogenous/semi-autogenous mills are commonly employed in the grinding process. The type of mill to be used is determined based on characteristics of the ore to be ground, input and output particle size of the product, and capacity. Parameters that affect grinding should be optimized to achieve a high-efficiency grinding process. Low grinding performance has a negative impact on post-grinding enrichment (gravity separation, flotation, and the like) and/or leaching processes and thus the metallurgic performance at the ore processing facility. That is because the particle size is one of the main parameters affecting enrichment and leaching processes. For all the above-mentioned reasons, one of the most important processes at an ore processing facility is the ore grinding stage.

In order to achieve an effective grinding process, the ore and the grinding environment (ball, rod, and the like) should first reach a certain height inside the rotating mill, and then the grinding environment should touch the ore upon falling inside the mill with centrifugal force and gravitational force. The interior of the mills is coated with liners and lifter bars in order to protect the mill body against abrasion and impart the ore and grinding environment motion required for the grinding to take place. Material for mill liners and lifter bars may include cast material, steel, ceramic, polymer-based materials, or elastic (rubber). Compared to cast and steel liners, rubber liners have more important technical and economic superiorities. Rubber liners now take over from cast and steel liners and become more widespread due to their following superiorities:
they reduce noise levels during the grinding process;
since rubber and cast/steel densities are 1.25 g/cm³ and 7.5 g/cm³ respectively, mill weight is reduced, and not only the weight that the mill bearings are exposed to but also the related mechanical failures are reduced;
a reduction in energy consumption of 4 to 5% is achieved;
cast and steel liners increase ball wear while rubber liners do not, therefore the use of rubber liners extend the physical life of balls and hence the reduction in ball consumption;
rubber wears away less than cast material due to its ability to absorb impact and therefore the physical life of liner is extended;
cost reduction is achieved;
a structure more resistant against many chemicals is formed;
higher strength against abrasive materials is obtained;
high resistance against corrosion is provided;
replacement and maintenance procedures are facilitated from a technical point of view.

Liners and lifter bars that are worn away beyond a certain critical level must be replaced in order to ensure that the grinding continues effectively. Replacement times for liners and lifter bars are within the duration of the warranty provided by the liner manufacturer. The determination of these times is performed based on experience. Production is paused at the ore facility during liner and lifter bar replacement. Performance of the liner and lifter bar replacement only when it is really necessary is critical in terms of keeping both production stoppages and costs to the minimum. Liner costs, together with the grinding environment and energy consumption, are one of the main cost items among mill operating costs.

There are four fundamental techniques employed to determine liner and lifter bar wear profile following the stopping of the mill. They are as follows: three-dimensional (3D) image analysis of mill interior with a three-dimensional laser scanner, image analysis of a certain part of the mill with a two-dimensional scanner, measurement with mechanical measuring tools (a kind of frame), and measurement with ultrasonic apparatus and acoustic sensors.

Complete imaging of the mill interior by way of the three-dimensional laser scanner provides a clear picture as to the change in liner and lifter bar levels. Acoustic (ultrasonic) sensors can also be used to measure rubber liners thicker than 40 cm. Additionally, mechanical measuring tools are utilized while determining liner and lifter bar wear profiles since they are simple, easy-to-use, and economical; and digital measuring devices are also available for the same task.

All of the above-mentioned techniques require the mill to be stopped to determine the wear level. The most appropriate liner and lifter bar replacement time is attempted to be foreseen with the obtained liner and lifter bar wear data. However, the mill has to be stopped to get information on liner and lifter bar wear with the existing knowledge and technological possibilities. This in turn leads to loss of time and money.

As a result of research on this topic, some works have been encountered. A company named RÖSLER TYRE INNOVATORS developed a system instantly tracking the wear of tire treads of heavy-duty trucks. The said system also measures instant temperature and tire pressure besides wear and allows satellite tracking of the truck's location. The system is developed and implemented only for trucks.

MillMapper technology developed by the company OUTOTEC is based on the principle of three-dimensional scanning of mill interior with a laser scanner system after the mill is stopped and then determining of wear levels. A company named MULTOTEC, on the other hand, creates a two-dimensional map of a desired portion of the liner profile thanks to a system called MultoScan.

A company named DIGITAL CONTROL LAB asserts that it improves grinding performance and reduces liner wear by measuring not only mill input and output tonnages but also vibration levels thanks to its MillSlicer technology. The said technology cannot directly measure the wear. The system called MineralScan developed by the same company, on the other hand, is similar to MillSlicer system, only at a lower cost.

The patent document with the publication number U.S. Pat. No. 7,677,079B2 describes a system for tracking the wear of mill liner and lifter bars. There was no information about the manufacturing of a product based on this patent and the industrial application thereof in mines. Moreover, an examination of the concerned patent shows that it does not mention that it enables tracking temperature and pressure, in addition to detecting the wear, and that there are different types of sensors. Another crucial point relating to the said patent document is that there is no mention of processes such as the transfer of measurement data to the cloud, as well as storage and modeling thereof, with the help of a wireless communication system. The patent document with the publication number U.S. Pat. No. 7,677,079B2 differs from the system of our work in light of all these explanations.

In conclusion, the requirement for the elimination of shortcomings and disadvantages of embodiments and practices existing in the prior art and already being used as of today entails an improvement in the respective technical field.

### Objective of the Invention

The present invention relates to a system that enables real-time monitoring of wear and tear occurring, over time, in rubber liners and lifter bars used in the internal structure of the ore grinding mills, in addition to obtaining estimations as to the replacement times of worn parts, wherein it is developed for eliminating the aforementioned disadvantages and providing new advantages to the respective technical field.

An objective of the present invention is to ensure that wear statuses of liners and lifter bars are monitored on a real-time basis and their replacement times are estimated in the most appropriate manner.

Another objective of the present invention is to allow instant monitoring of other parameters such as temperature and pressure that affect wear, besides wear level.

A further objective of the present invention is to ensure a significant reduction in manufacturing costs by preventing stoppages resulting from liner and lifter bar replacement procedures. For example, the hourly cost of a stoppage of ore grinding mills at a gold mine differs between 35,000 $ and 50,000 $, and the replacement of a large-scale mill takes about 12 to 24 hours.

Another objective of the present invention is to ensure modeling of the wear behaviors of liners and lifter bars, as well as the relationship between wear and ore properties, and generating wear estimations for the following periods.

A further objective of the present invention is to ensure that wear data about liners and lifter bars of different types of ores are collected on a single database thanks to the application of the system in different mines, thereby enabling to make the most accurate estimation as to the wear of liners and lifter bars for a mill that will be lined with rubber for the first time.

Another objective of the present invention is to prevent the replacement of liners and lifter bars before they are completely worn away thanks to the data obtained with instant monitoring of liners and lifter bars, and therefore minimize environmental damage due to the manufacturing of liners and lifter bars and provide savings.

A further objective of the present invention is to allow determining the efficiency of the geometry of the liner and lifter bar in use and, if needed, improving the geometrical design before liner and lifter bar replacement.

Structural and characteristic features of the invention, as well as all of its advantages, will be understood more clearly with the FIGURES given below and the detailed description written by referring to the relevant FIGURES, and therefore, the evaluation should be made by taking into consideration of the said FIGURES and detailed description.

### SHORT EXPLANATION OF FIGURES

The applications of the present invention that is briefly summarized above and addressed in detail below can be understood by referring to the sample applications depicted in the attached drawings of the invention. However, it must be stated that the attached drawings show only the typical applications of this invention and that since the invention allows other equally effective applications, its scope cannot be assumed to be limited.

In order to facilitate understanding, identical reference numbers are used to indicate identical elements in the FIGURES, where possible. The shapes are not drawn to scale and can be simplified for clarity. It is believed that the elements and features of an application can be usefully incorporated into other applications without further explanation.

FIG. 1: It is a schematic view of the system of the invention.

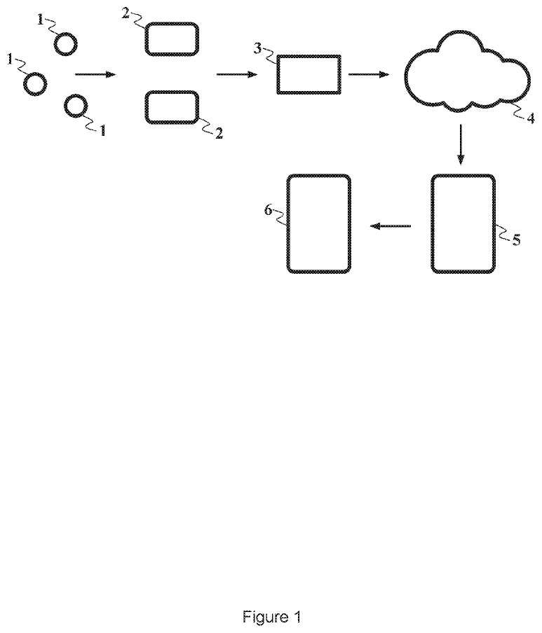

### REFERENCE NUMBERS

1. Sensing module
2. Data collection node
3. Communication coordinator
4. Cloud/internet
5. Data collection monitoring and estimation center
6. Reporting and user interface

### DETAILED EXPLANATION OF THE INVENTION

The preferred alternatives in this detailed description of the system of the present disclosure are only intended for providing a better understanding of the subject matter and should not be construed in any restrictive sense.

The invention relates to a system that enables real-time monitoring of wear and tear occurring, over time, in rubber liners and lifter bars used in the internal structure of the ore grinding mills employed in the mining sector, in addition to obtaining accurate and realistic estimations about the wear.

The solution suggested with the invention is that an embedded system technology is developed with special sensing modules (1) to be placed inside the liners and lifter bars utilized in the mills and that wear, performance, and other parameters are instantly monitored and controlled with this system. The sensing modules (1) consist of electromechanical sensors, capacitive sensors, and acoustic sensors.

The invention consists of the sensing modules (1) that allow measuring wear level, temperature, and pressure of rubber liners. Data coming from the sensing modules (1) are transferred to the data collection nodes (2) placed outside of the mill in a wired or wireless manner, from there to the communication coordinator (3) in a wireless manner, and from there to the data collection monitoring and estimation center (5) with the help of the cloud/internet (4). Data and analysis results in the data collection monitoring and estimation center (5) can be accessed from the reporting and user interface (6).

Based on the data collected by the system, estimation models are created with artificial intelligence approaches, primarily time-series estimation models, and liner and lifter bar wear is estimated for different ores.

The wear level, temperature, and pressure of liners and lifter bars are measured by the sensing modules (1), which are a part of the system of the invention. Lifter bar temperature is measured within a range of −40° C. to +125° C. and with an accuracy of 1° C. by way of a semi-conductive temperature sensor placed on the motherboard in the sensing modules (1). Pressure on the lifter bar, on the other hand, is measured with a load cell and a low-noise high-profit amplifier. The obtained wear, temperature, and pressure data are transferred, in a wired or wireless manner, at the speed of 9600 bps by asynchronous series communication to the data collection nodes (2) with the data package determined by a microcontroller placed on the sensing modules (1).

There are four cables between the sensing modules (1) and the data collection nodes (2). Two of these are used to provide energy to the sensing modules (1), the command is conveyed to the sensing modules (1) with the third one, and the fourth one allows reading measurement data. The communication speed between the sensing modules (1) and the data collection nodes (2) is determined as 9600 bps. This speed may software-wise be altered between 110 bps and 115200 bps. Additionally, bidirectional wireless communication is also possible between the sensing modules (1) and the data collection nodes (2), if need be.

The data collection nodes (2) re-package measurement data obtained from all sensing modules (1) they are connected to and transfer to the communication coordinator (3) wirelessly. The data received by the communication coordinator (3) are uploaded to the cloud/internet (4) via Ethernet. The data obtained from the cloud/internet (4) are sent to the data collection monitoring and estimation center (5), and values such as wear, temperature, pressure are monitored real-time by way of the analysis of the relevant data; moreover, liner and lifter bar wear is estimated for different ores by using artificial intelligence. The reporting and user interface (6) is utilized to access the relevant monitoring data and analysis and estimation results.

Communication protocols employed in the system of the invention differ according to the locations of the ore grinding mills and their relevant conditions; and WiFi, Ethernet, ZigBee, LoRaWAN, cellular network (3G), and satellite communication are among the options.

What is claimed is:

1-3. (canceled)

4. A system that enables real-time monitoring of wear and tear occurring in rubber liners and lifter bars used in an internal structure of ore grinding mills, in addition to obtaining estimations as to replacement times of worn parts by evaluating the estimations according to different ore types by employing artificial intelligence approaches, the system comprising:
sensing modules positioned inside the rubber liners and the lifter bars that sense the wear and tear occurring over time in the rubber liners and lifter bars in the internal structure of the ore grinding mills, as well as temperature and pressure, wherein the sensing modules comprise electromechanical and acoustic sensors;
data collection nodes positioned outside of a mill that reads measurement data from the sensing modules, wherein a command is transmitted and energy is provided to the sensing modules;
a communication coordinator that transfers data from the data collection nodes to a cloud/internet, wherein the measurement data from the sensing modules are wirelessly transferred to the communication coordinator;
a data collection monitoring and estimation center that stores data from the communication coordinator via the cloud/internet, and instantly monitors the data, and makes analyses and estimations with an artificial intelligence approach by using the data; and
a reporting and user interface that allows users to access real-time monitoring data, analysis, and estimation results.

5. The system of claim 4, wherein the communication coordinator utilizes a communication protocol according to locations of the ore grinding mills and relevant conditions of the ore grinding mills, and wherein the communication protocol comprises any of WiFi, Ethernet, ZigBee, LoRaWAN, cellular network, and satellite communication.

6. A method of operating a system that enables real-time monitoring of wear and tear occurring in rubber liners and lifter bars used in an internal structure of ore grinding mills, in addition to obtaining estimations as to replacement times of worn parts by evaluating the estimations according to different ore types by employing artificial intelligence approaches, the method comprising:
instantly measuring wear level, temperature, and pressure in the rubber liners and the lifter bars by sensing modules;
transferring data coming from the sensing modules to data collection nodes that are positioned outside of a mill;
wirelessly transferring data read by the data collection nodes to a communication coordinator;
transferring data received at the communication coordinator to a data collection monitoring and estimation center through a cloud/internet;
storing and monitoring data gathered at the data collection monitoring and estimation center in real-time;
creating estimation models based on monitored data with artificial intelligence approaches comprising time-series estimation models;
estimating wear and tear of the rubber liners and lifter bars for different ores; and
accessing data, analysis, and estimation results in the data collection monitoring and estimation center through a reporting and user interface.
